(19) United States
(12) Patent Application Publication
(10) Pub. No.: US 2026/0312926 A1
(43) Pub. Date: Oct. 8, 2026

(54) INFORMATION PROCESSING SYSTEM, INFORMATION PROCESSING METHOD, AND PROGRAM

(71) Applicant: Communitio Corporation, Tokyo (JP)

(72) Inventors: Satoru ISHIKAWA, Tokyo (JP); Mitsutaka TAKEDA, Tokyo (JP); Wataru IIDA, Tokyo (JP)

(21) Appl. No.: 19/479,181

(22) PCT Filed: Apr. 11, 2024
(86) PCT No.: PCT/JP2024/014660

§ 371 Date: Oct. 27, 2025

(30) Foreign Application Priority Data
Apr. 27, 2023 (JP) 2023-073188

(51) Int. Cl. H04L 51/214; G06Q 10/107

(52) U.S. Cl. CPC H04L 51/214; G06Q 10/107

(57) ABSTRACT

[Object] To reduce unnecessary redelivery of a message simultaneously delivered.

[Solving Means] An information processing system includes a controller. The controller simultaneously delivers a message to all of a plurality of users belonging to a predetermined user group, as destination users, on the basis of a request from a sender terminal. Further, the controller calculates a parameter for each of the users by a predetermined algorithm in accordance with a reaction of the user to the message, selects a destination user to be a destination to whom the message is to be redelivered, or a destination user to be a destination to whom a message related to the message is to be delivered, from all of the users on the basis of the calculated parameter, and redelivers the message or delivers the related message to the selected destination user.

### TECHNICAL FIELD

The present invention relates to an information processing system, an information processing method, and a program that are capable of simultaneously delivering a message to a plurality of members.

### BACKGROUND ART

Conventionally, simultaneous delivery of a message to all users belonging to a certain group has been performed. For example, Patent Literature 1 below describes that, in a company, a mail is simultaneously delivered to all employees from an intra-company mail server and the employees receive that mail in their own smart devices.

### CITATION LIST

### Patent Literature

Patent Literature 1: Japanese Patent No. 6202650

### DISCLOSURE OF INVENTION

### Technical Problem

However, when simultaneous delivery of an e-mail is performed, the e-mail is buried in other business mails and the contents thereof are not known, and thus the simultaneous delivery has to be repeated many times. On the other hand, users who have already opened the e-mail and responded thereto feel uncomfortable every time they receive such simultaneously delivered mails, and become reluctant to open such mails.

In view of the circumstances as described above, it is an object of the present invention to provide an information processing system, an information processing method, and a program that are capable of reducing unnecessary redelivery of a message simultaneously delivered or unnecessary delivery of a message related to the above message.

### Solution to Problem

In order to achieve the above object, an information processing system according to an embodiment of the present invention includes a controller. The controller simultaneously delivers a message to all of a plurality of users belonging to a predetermined user group, as destination users, on the basis of a request from a sender terminal. Further, the controller calculates a parameter for each of the users by a predetermined algorithm in accordance with a reaction of the user to the message, selects a destination user to be a destination to whom the message is to be redelivered, or a destination user to be a destination to whom a message related to the message is to be delivered, from all of the users on the basis of the calculated parameter, and redelivers the message or delivers the related message to the selected destination user.

With this configuration, the information processing system extracts a user in accordance with the reaction of the user to the simultaneously delivered message, and redelivers the message or delivers the related message. This makes it possible to reduce unnecessary redelivery of the message simultaneously delivered or unnecessary delivery of a message related to the above message.

The controller may generate a recommending screen capable of recommending redelivery of the message to the selected destination user and receiving a request of the redelivery, transmit the recommending screen to the sender terminal, and redeliver the message when the request of the redelivery is received from the recommending screen.

With this configuration, the information processing system can cause the sender to know a user to whom the message is to be redelivered.

The controller may calculate an activity value corresponding to an activity on a user terminal of each user with respect to the simultaneously delivered message, and an attribute value corresponding to an attribute of the message, and may calculate the parameter on the basis of the activity value and the attribute value.

With this configuration, the information processing system can reduce time and effort of the sender by automatically redelivering a message to a user to whom the message is to be redelivered.

The controller may calculate the activity value on the basis of time taken until the simultaneously delivered message has been opened by the user, the number of times the message has been opened, time in which the message has been displayed after opened, or the number of times a hyperlink set in the message has been pressed.

With this configuration, the information processing system can determine the interest level of the user in the simultaneously delivered message and redeliver the message only to a user interested in the message.

The controller may calculate the attribute value on the basis of the degree of importance or the degree of urgency of the simultaneously delivered message, a category of message contents, or information related to a delivery source.

With this configuration, the information processing system can redeliver the message only to a user highly relevant to the simultaneously delivered message.

The controller may calculate the parameter further on the basis of an activity history value corresponding to the activity of each user with respect to a message simultaneously delivered before the simultaneously delivered message.

With this configuration, the information processing system can select a user to whom the message is to be redelivered, with high accuracy, by also considering the user's reaction to past messages.

The controller may determine a user belonging to the predetermined user group in accordance with a parameter calculated in accordance with a reaction of the user to a message simultaneously delivered in a past.

With this configuration, the information processing system can narrow down in advance users of a user group to whom the message is to be simultaneously delivered.

The controller may train a convolutional neural network on the basis of data showing the reaction to a message simultaneously delivered in a past, generate a calculation model of the parameter as the predetermined algorithm, and calculate, using the calculation model, the parameter on the basis of data showing the reaction of the user to the message simultaneously delivered.

This configuration makes it possible to accelerate the calculation processing of the parameter and also cope with the case where the amount of calculation becomes enormous due to an increase in the number of destination users, or the like.

An information processing system according to another embodiment of the present invention includes a controller. The controller simultaneously delivers a message to all of a plurality of users belonging to a predetermined user group, as destination users, on the basis of a request from a sender terminal. Further, the controller determines for each of the users whether or not a reaction of the user to the message satisfies a plurality of conditions, selects a destination user to be a destination to whom the message is to be redelivered, or a destination user to be a destination to whom a message related to the message is to be delivered, from all of the users in accordance with a result of the determination, and redelivers the message or delivers the related message to the selected destination user.

An information processing method according to another embodiment of the present invention includes:
simultaneously delivering a message to all of a plurality of users belonging to a predetermined user group, as destination users, on the basis of a request from a sender terminal;
calculating a parameter for each of the users by a predetermined algorithm in accordance with a reaction of the user to the message;
selecting a destination user to be a destination to whom the message is to be redelivered, or a destination user to be a destination to whom a message related to the message is to be delivered, from all of the users on the basis of the calculated parameter; and
redelivering the message or delivers the related message to the selected destination user.

A program according to still another embodiment of the present invention causes an information processing apparatus to execute the steps of:
simultaneously delivering a message to all of a plurality of users belonging to a predetermined user group, as destination users, on the basis of a request from a sender terminal;
calculating a parameter for each of the users by a predetermined algorithm in accordance with a reaction of the user to the message;
selecting a destination user to be a destination to whom the message is to be redelivered, or a destination user to be a destination to whom a message related to the message is to be delivered, from all of the users on the basis of the calculated parameter; and
redelivering the message or delivering the related message to the selected destination user.

### Advantageous Effects of Invention

As described above, according to the present invention, it is possible to reduce unnecessary redelivery of a message simultaneously delivered. However, this effect does not limit the present invention.

### BRIEF DESCRIPTION OF DRAWINGS

FIG. 1 is a diagram showing a configuration of a message delivery system according to an embodiment of the present invention.

FIG. 2 is a diagram showing a hardware configuration of a delivery server according to the embodiment of the present invention.

FIG. 3 is a diagram showing a configuration of a database included in the delivery server according to the embodiment of the present invention.

FIG. 4 is a sequence diagram showing a flow of message redelivery processing by the message delivery system according to the embodiment of the present invention.

FIG. 5 is a diagram showing an example of a message delivery contents creation screen that is provided to a user terminal by the delivery server according to the embodiment of the present invention.

FIG. 6 is a flowchart showing a detailed flow of interest level parameter calculation processing in FIG. 4.

FIG. 7 is a diagram showing a specific example of the interest level parameter calculation processing in FIG. 6.

FIG. 8 is a diagram showing an example of a message redelivery recommending screen that is provided to the user terminal by the delivery server according to the embodiment of the present invention.

FIG. 9 is a diagram for describing conditions of automatic redelivery processing by a delivery server according to another embodiment of the present invention.

### MODE(S) FOR CARRYING OUT THE INVENTION

Hereinafter, an embodiment of the present invention will be described with reference to the drawings.

### Configuration of System

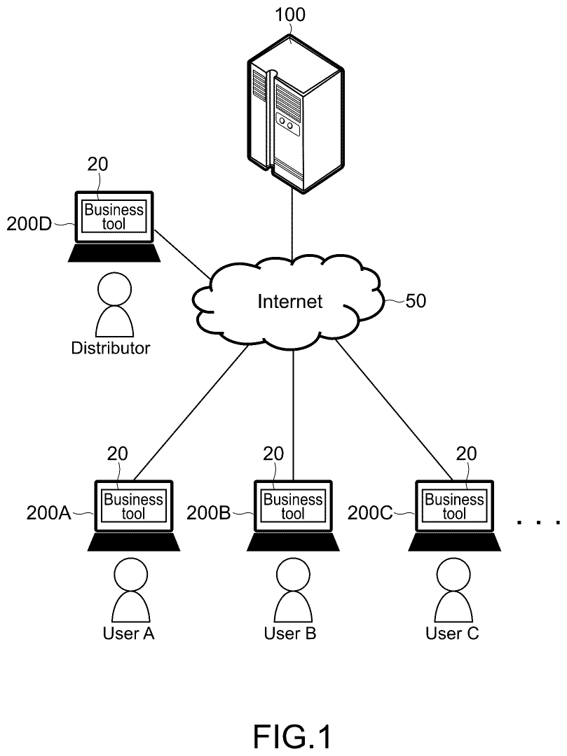

FIG. 1 is a diagram showing a configuration of a message delivery system according to this embodiment.

As shown in the figure, this system is configured by connecting a delivery server 100 and a plurality of user terminals 200 in each company via a network such as the Internet 50.

The user terminal 200 is a terminal used by a user who is an employee of a company, and is, for example, a notebook personal computer (PC), a desktop PC, a smartphone, or a tablet PC.

A business communication tool 20 (hereinafter, also referred to simply as business tool 20), which is used by employees of each company to communicate with each other in their work, is installed on the user terminal 200.

The business communication tool 20 is, for example, groupware such as Microsoft Teams (registered trademark) or Slack (registered trademark), a messaging application, a group chat application, a social networking service (SNS) for business use, or a mailer, but is not limited thereto. In this embodiment, an example in which Microsoft Teams (registered trademark) is used as an example of the business tool 20 will be described.

The business tool 20 has a chat/call function, a video conference function, a file sharing function, and the like among registered employee groups. In addition, the business tool 20 also has a function of simultaneously delivering various messages to all users of a group constituted by a plurality of users (e.g., all employees of a company, employees of a particular department, etc.).

The delivery server 100 is a server capable of mediating communication between the user terminals 200 using the business tools 20 and also simultaneously delivering a message to users of a predetermined user group on the basis of a request from a user terminal 200 of a delivery source (distributor) of the message simultaneously delivered.

In this embodiment, after simultaneously delivering the message to all the users of the user group, the delivery server 100 can calculate an interest level parameter for each of the users by a predetermined algorithm in accordance with a reaction of each user to the message, select a destination user, who is a destination to which the message is to be redelivered, from all the users of the user group in accordance with the interest level parameter, and redeliver the message to the selected destination user.

### Hardware Configuration of Delivery Server

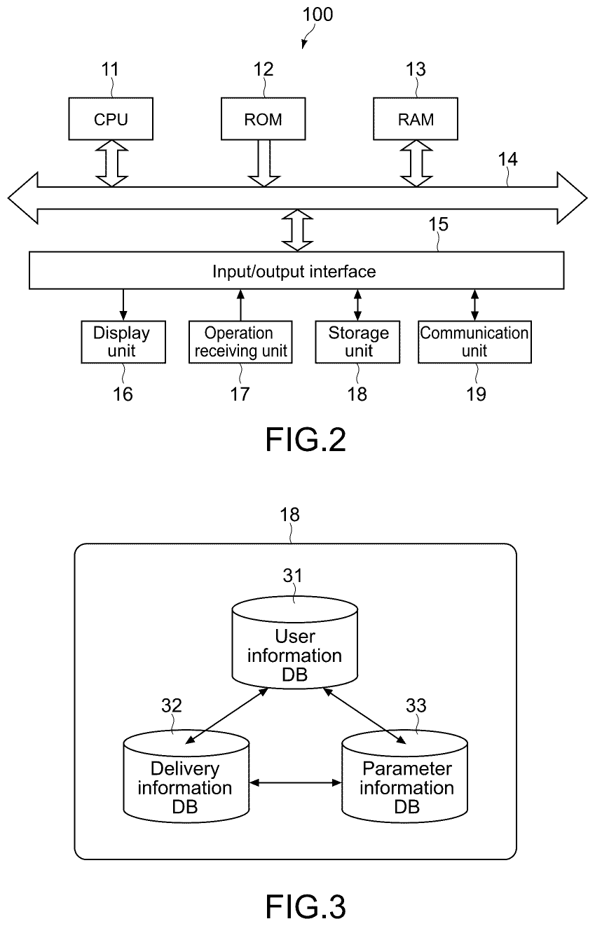

FIG. 2 is a diagram showing a hardware configuration of the delivery server 100. As shown in the figure, the delivery server 100 includes a central processing unit (CPU) 11, a read only memory (ROM) 12, a random access memory (RAM) 13, an input/output interface 15, and a bus 14 that connects those components to each other.

The CPU 11 appropriately access the RAM 13 and the like as necessary and collectively controls the whole of each block of the delivery server 100 while performing various types of arithmetic processing. The ROM 12 is a non-volatile memory in which firmware such as the operating system (OS) to be executed by the CPU 11, programs, and various parameters are fixedly stored. The RAM 13 is used as a work area or the like for the CPU 11, and temporarily holds the OS, various applications being executed, and various types of data being processed.

A display unit 16, an operation receiving unit 17, a storage unit 18, a communication unit 19, and the like are connected to the input/output interface 15.

The display unit 16 is, for example, a display device using a liquid crystal display (LCD), an organic electroluminescence display (OELD), a cathode ray tube (CRT), or the like.

The operation receiving unit 17 is, for example, a pointing device such as a mouse, a keyboard, a touch panel, or another input device. If the operation receiving unit 17 is a touch panel, the touch panel may be integrated with the display unit 16.

The storage unit 18 is, for example, a non-volatile memory such as a hard disk drive (HDD), a flash memory (SSD; solid state drive), or another solid-state memory. The storage unit 18 stores the OS, various applications, and various types of data.

In particular, in this embodiment, the storage unit 18 stores information related to a user to be a destination to which a message is to be simultaneously delivered, information related to the message, information related to a reaction of the user to the message, and the like and also stores applications and other programs for the delivery server 100 to execute message simultaneous delivery processing by using the above data. The storage unit 18 contains, as databases including the above data, a user information database, a delivery information database, and a parameter information database, as will be described later.

The communication unit 19 is, for example, various modules for wireless communication, such as Ethernet NIC (Network Interface Card) or a wireless LAN, and performs processing of communicating with the user terminal 200.

Although not shown in the figure, the hardware configuration of the user terminal 200 is similar to the hardware configuration of the delivery server 100.

### Database Configuration of Delivery Server

FIG. 3 is a diagram showing a configuration of a database included in the delivery server 100.

As shown in the figure, the delivery server 100 includes a user information database 31, a delivery information database 32, and a parameter information database 33 in the storage unit 18.

The user information database 31 stores user information of each employee, that is, information such as a user name, a user ID, a post, the department to which the user belongs, the date when the user joined the company, age, gender, and an address.

The delivery information database 32 stores, in addition to the information containing messages that have been simultaneously delivered so far and messages that are to be delivered in the future (title, body text, image, and destination user), the degree of importance, the degree of urgency, and the genre of messages (personnel information, information related to company status, notice of health checkup, notice of system maintenance, notice of holding workshop, notice of holding entrance ceremony, notice of safety confirmation, etc.), a distributor (management such as company president, human resources department, general person in charge in IT department, etc.), and other attribute information of each message.

The parameter information database 33 stores, for each of the users, information indicating a user's reaction to the message simultaneously delivered (user activity information), specifically, information such as the number of times the message has been opened, the number of days taken until the message has been opened, time in which the message has been displayed after opened, the number of times a hyperlink set in the message has been pressed, or the presence/absence of a delivery archive. Further, the parameter information database 33 also stores, for each of the users, information indicating an interest level parameter calculated on the basis of the user activity information and the attribute information.

Those databases are referenced to each other as necessary and used in the message simultaneous delivery processing (and redelivering processing) by the delivery server 100, which will be described later.

### Operation of System

Next, the operation of the message delivery system configured as described above will be described. The operation is executed by cooperation of the hardware such as the CPU 11 and the communication unit 19 of the delivery server 100, and the software stored in the storage unit 18. In the following description, for the purpose of convenience, the CPU 11 will be a main operating subject in the delivery server 100.

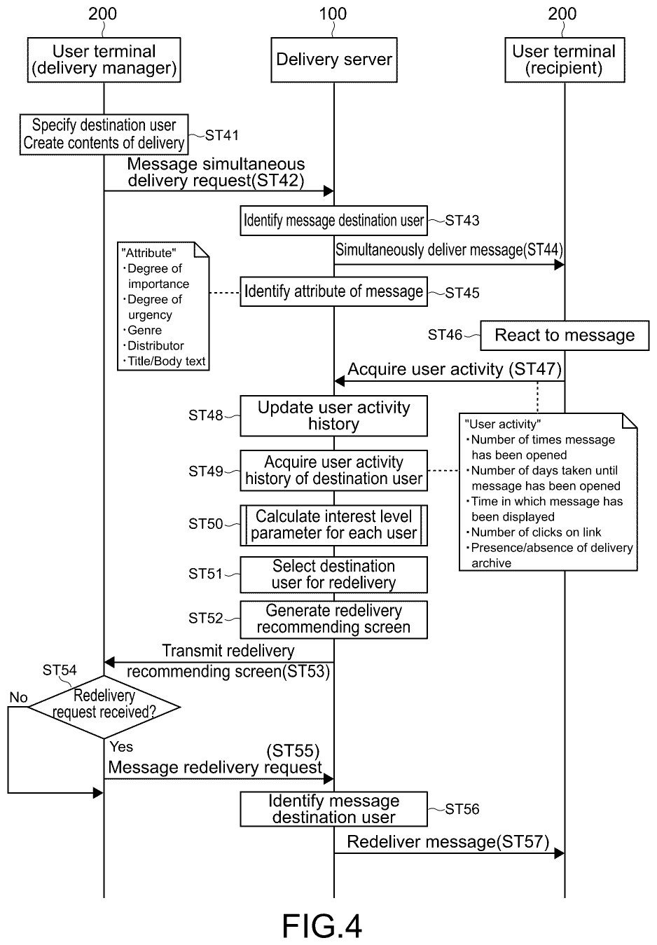

FIG. 4 is a sequence diagram showing a flow of message redelivery processing by the message delivery system according to this embodiment. As described above, the delivery server 100 simultaneously delivers a message to all users of a user group as destinations, calculates an interest level parameter for each of the users by a predetermined algorithm on the basis of the user's reaction to the message, and redelivers the message to the users extracted on the basis of the interest level parameters as destination users.

As shown in the figure, first, the user terminal 200 of the message distributor uses the business tool 20 to determine destination users to whom a message is to be simultaneously delivered and create contents of the message (Step 41). The destination users can be determined by, for example, selecting a user group from options such as “all employees”, “all employees of xx department”, and “all new employees” on a message delivery screen.

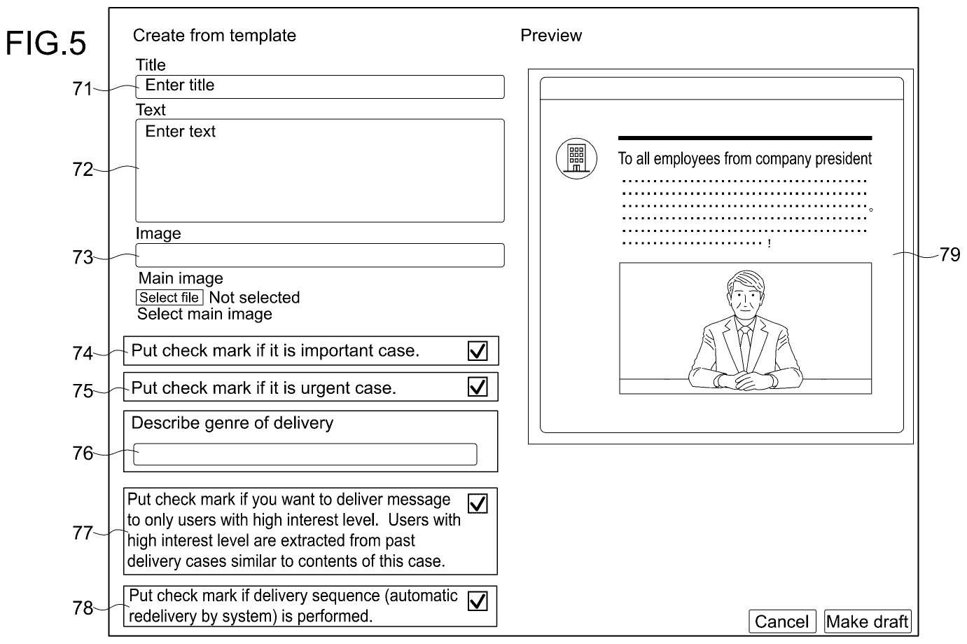

In addition, the contents of the message can be created on a message delivery contents creation screen that is provided by the business tool 20. FIG. 5 is a diagram showing an example of the message delivery contents creation screen.

As shown in the figure, the message delivery contents creation screen includes a title entry field 71, a body text entry field 72, an image entry field 73, a degree-of-urgency check mark field 74, a degree-of-importance check mark field 75, a genre entry field 76, a user narrowing-down check mark field 77, a sequencing check mark field 78, and a preview field 79.

The title entry field 71, the body text entry field 72, and the image entry field 73 are fields for entering a title, a body text, and an image of the message to be delivered, respectively.

The degree-of-urgency check mark field 74 and the degree-of-importance check mark field 75 are fields for entering or not entering a check mark as to whether the degree of urgency and the degree of importance of the message are high or not, respectively.

The genre entry field 76 is a field for entering the genre (category) of the message contents. As described above, for example, information such as personnel information, information related to a company status, a notice of a health checkup, a notice of system maintenance, a notice of holding a workshop, a notice of holding an entrance ceremony, and a notice of a safety confirmation can be entered.

The user narrowing-down check mark field 77 is a check mark field that is used when the distributor wants to narrow down the destinations of the message, which is being created on the message delivery contents creation screen, to the users who seem to have a high interest level among the users of the selected user group, and then deliver a message to them.

If a check mark is put into the user narrowing-down check mark field 77, the CPU 11 narrows down the users to those who show a high interest level in the previously delivered messages similar to the contents of each field being currently entered, as destination users. As the specific technique, an algorithm similar to the algorithm in message redelivery, which will be described later, is used.

The sequencing check mark field 78 is a check mark field that is used when the distributor wants the delivery server 100 to automatically execute the message redelivery processing, which will be described later.

The preview field 79 is a field for displaying a preview screen on the basis of the contents of the title entry field 71, the body text entry field 72, and the image entry field 73.

Referring back to FIG. 4, if the creation of the message on the message delivery contents creation screen is completed, the user terminal 200 of the distributor transmits, to the delivery server 100, a simultaneous delivery request of the created message to the users of the user group (Step 42). The simultaneous delivery request contains the information of each field entered through the message delivery contents creation screen and the information indicating the distributor (message creator).

If receiving the simultaneous delivery request of the message, the CPU 11 of the delivery server 100 identifies destination users of the message contained in the delivery request (Step 43).

Subsequently, the CPU 11 simultaneously delivers the message to the identified destination users (Step 44).

Subsequently, the CPU 11 identifies the attribute (property) of the delivered message (Step 45). The attribute of the message is, for example, the degree of importance, the degree of urgency, and a genre of the message (personnel information, information related to company status, etc.), a distributor (management such as company president, human resources department, general person in charge in IT department, etc.), and the simplicity, visibility, or the like of the title and the body text, and is identified from information of each field of the delivered message. For the distributor, on the basis of the user name or user ID contained in the delivery request, the user's post and department are referenced from the user information database 31. The simplicity or visibility of the title and the body text is determined using predetermined criteria, for example, whether or not the title contains words indicating a specific genre, and whether or not the body text is too long. Note that the processing of identifying the attribute may be executed before the message simultaneous delivery processing.

Subsequently, if there is a reaction of the destination user to the delivered message on the user terminal 200 (Step 46), the CPU 11 acquires information related to the reaction as user activity information (Step 47).

The user activity information includes information such as time (number of days) taken until the message has been opened from the message delivery time (date), the number of times the delivered message has been displayed, the total time in which the message has been displayed, the number of times a hyperlink embedded in the message has been pressed, whether or not the same message has been displayed on a plurality of devices, whether or not the same message has been displayed on a plurality of user terminals 200, and whether or not the message has been archived privately. If those activities are detected by the business tools 20 of the respective user terminals 200, a notification of that effect is transmitted from the business tools 20 to the delivery server 100.

Subsequently, when acquiring the user activity information, the CPU 11 updates user activity history information stored so far in the parameter information database 33 (Step 48).

Subsequently, the CPU 11 acquires the user activity history information of the destination users who are the same as destination users of the message simultaneously delivered just before the message delivery in this time (Step 49).

Subsequently, the CPU 11 calculates an interest level parameter for each of the users on the basis of the acquired user activity information, the user activity history information, and the attribute information of the message (Step 50). This is because the user's interest level in the message can be measured from the user's reaction to the message (user activity), whereas it is also related to the attribute (property) of the message.

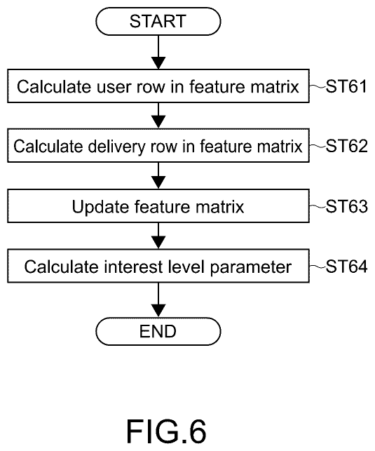

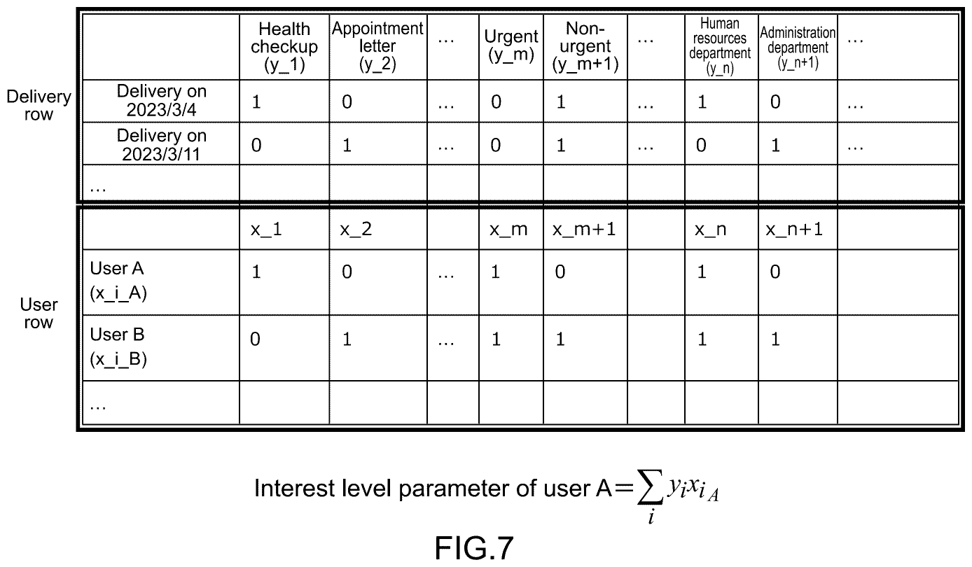

FIG. 6 is a flowchart showing a detailed flow of the interest level parameter calculation processing. In addition, FIG. 7 is a diagram showing a specific example of the interest level parameter calculation processing.

As the algorithm for calculating the interest level parameter, for example, contents-based filtering is used. As shown in FIG. 7, the user activity history is represented by a feature matrix (for simplicity, the elements are limited to 0 and 1) in which “attribute of message” is “delivery row”, and “user activity” is “user row”, to thereby calculate an interest level parameter from the sum of the inner products of the “delivery row” and “user row” vectors.

In the delivery row, the attribute (property) of the message is determined using 0 or 1 and represented as a feature matrix. For example, attribute elements related to the genre of message, such as “health checkup” and “appointment letter”, attribute elements related to the degree of urgency of message, such as “urgent” and “non-urgent”, and attribute elements related to a distributor (department of delivery source), such as “human resources department” and “administration department”, are set, and the attribute of the message at each time is represented by the value 0 or 1 of each attribute element (if it corresponds to each attribute, 1; if not, 0).

Specifically, for example, the value of each element is determined as follows.
(1) Since the distributor belongs to the human resources department, the value of a ‘human resources department’ element of y_n is set to ‘1’.
(2) If the distributor specifies the degree of urgency of delivery as urgent on the message delivery contents creation screen, the value of an ‘urgent’ element of y_m is set to ‘1’.
(3) Words that correlate with the degree of urgency, such as ‘immediately’, ‘hurry’, and ‘short delivery deadline’, may be defined in advance to determine the degree of urgency in accordance with the frequency of use of those words in the title or body text of the message. For example, if the frequency of use exceeds three times, the value of the ‘urgent’ element of y_m can be determined to be ‘1’.
(4) By cooperation with generative AI tools for natural languages, such as ChatGPT, the delivered contents may be read to determine the value of the ‘urgent’ item of y_m to be ‘1’ or ‘0’, or a system manager may determine it in a subjective manner.
(5) The genre of message, and the simplicity/visibility of delivery may also be determined by generative AI tools for natural languages, or may be determined by a system manager in a subjective manner.

To determine each attribute element of message to be 0 or 1, the distributor may perform manual setting (describe the genre of delivery, set the presence/absence of the degree of urgency) on the message delivery contents creation screen at the time of delivery, or may cause a generative AI tool for natural languages, such as ChatGPT, to read delivery information (title, body text, image, etc.) for automatic setting.

In both cases of manual setting and automatic setting, the attribute elements of “delivery row”, such as y_1 (health checkup) and y_2 (appointment letter), can be added or deleted by an operationally suitable method. Examples of operationally suitable methods include a method in which a system manager reviews the attribute elements yearly, and a method in which the system automatically deletes the items for which similar contents have not been delivered for more than one year since the previous delivery.

For each element of “delivery row”, weighting may be set as appropriate. For example, when the value of the ‘administration department’ element of y_n+1 is set to ‘1’, the human resources department, which performs delivery with a high interest level of users, can set the value of the ‘human resources department’ element of y_n to ‘2’. The weight may be set to 0 for at least one element.

Similarly, weighting may be performed as appropriate for the same item element on different dates of delivery. For example, a system manager may perform weighting such that, for the ‘urgent’ element of y_m, when the value of the delivery on Mar. 4, 2023 is set to ‘1’, the value of the delivery on Mar. 11, 2023 is set to ‘2’.

In addition, weighting can also be performed using statistical processing. For example, for the ‘urgent’ element of y_m, the frequency of use of the words that correlate with the degree of urgency in the message is normally distributed with a mean of three times and a standard deviation of 1, the frequency of use of five times has a low probability of 5.4%, and if the frequency of use of three times is set to ‘1’, the inverse of the probability (=1/0.054) may be weighted as ‘18.5’.

In the user row, the user's reaction (“user activity”) of the user terminal 200 to the message is determined using 0 or 1 and represented as a feature matrix. The user activity with respect to the attribute element of the message is represented by the value of 0 or 1 (if the user is determined to have an interest in each attribute element, 1; if determined to have no interest, 0) (activity value).

Specifically, for example, the value of each element is determined as follows.
(1) If a user A's interest in health checkup is specified in advance, the value in the first column of x_1_A (‘health checkup’ element) is set to ‘1’.
(2) If the user A has opened a message related to a health checkup within three days (“the number of days taken until the message has been opened” is within three days), the value in the first column of x_1_A (‘health checkup’ element) is set to ‘1’.
(3) If a user B has opened (displayed) three times or more a message of an appointment letter delivered from the human resources department, the value of the ‘appointment letter’ element of x_2_B is set to ‘1’, and the value of the ‘human resources department’ element of x_n_B is set to ‘1’.
(4) In (1) described above, the value is determined by “the number of days taken until the message has been opened”, but the value may be determined by “the number of times the message has been opened” for the first column (‘health checkup’ element) of x_1_A. If the message has been opened (displayed) three times or more, the value of the ‘health checkup’ element of x_1_A is set to ‘1’. The system manager can appropriately set which of the elements is used for determination.
(5) In (3) described above, the value is determined by either one of “the number of days taken until the message has been opened” or “the number of times the message has been opened”, but the value may be determined using two of “the number of days taken until the message has been opened” and “the number of times the message has been opened”. In other words, if the user has opened the message within three days and has opened it three times or more, the value of the ‘health checkup’ element of x_1_A is set to ‘1’. In addition, other user activities such as “display time” (e.g., if the message has been displayed for more than one hour in total, 1; if not, 0) and “presence/absence of a private archive” (if the message has been archived, 1; if not, 0) may be added to determine the value using a plurality of, three or more, elements, which can be set by the system manager as appropriate.
(6) In such a manner that the value of x_1 (health checkup) is determined by two of “the number of days taken until the message has been opened” and “the number of times the message has been opened”, and the value of x_2 (appointment letter) is determined by four of “the number of days taken until the message has been opened”, “the number of times the message has been opened”, “display time”, and “presence/absence of a private archive”, the number and type of elements of user activities used for determination may be different for each item of “user row”, and can be set by the system manager as appropriate.

In order to determine “user activity” with respect to the message by using 0 or 1, manual setting by the user him/herself (specifying an interested genre in advance, etc.) may be performed or automatic setting may be performed, on the basis of whether or not the reaction data of the user with respect to the delivery (=user activity) meets predetermined criteria. In both cases of manual setting and automatic setting, the items of “delivery row”, such as y_1 (health checkup) and y_2 (appointment letter), can be added or deleted by an operationally suitable method. Examples of operationally suitable methods include a method in which a system manager reviews the attribute elements yearly, and a method in which the system automatically deletes the items for which similar delivery has not been performed for more than one year since the previous delivery.

For each element of “user row”, weighting may be set as appropriate. For example, when the value of a user A ‘administration department’ element of x_n+1_A is set to ‘1’, the human resources department can deliver a message with a high interest level of the user such that the value of the ‘human resources department’ element of x_n_A is set to ‘2’. The weight may be set to 0 for at least one element.

Similarly, weighting may be performed as appropriate by a system manager for the same item element of different users. For example, the system manager may perform weighting such that, when the value of the user A ‘urgent’ element of x_m_A is set to ‘1’, the value of the user B ‘urgent’ element of x_m_B is set to ‘2’.

In addition, weighting can also be performed using statistical processing. For example, for the user A ‘urgent’ element of x_m_A, the number of days taken from the delivery of the message to the opening of the message is normally distributed with a mean of three days and a standard deviation of 1. If the user A has opened the message in one day from the delivery, this occurs at a frequency with a low probability of 5.4%. Thus, if the user who has opened the message in three days is set to ‘1’, the inverse of the probability (=1/0.054) may be weighted as ‘18.5’ for the user A ‘urgent’ element.

As the algorithm for calculating the interest level parameter of the user, the inner product of the above feature matrix is just one example, and other algorithms may be used. Alternatively, the interest level parameter may be automatically calculated using the user's interest level as output data, by machine learning or AI, with the “delivery row” and the “user row” being used as two input data.

In particular, each time the number of deliveries (number of destination users) increases, or each time the number of items of the attributes increases, the amount of information for calculating parameters becomes enormous. In addition, as the parameters are made more precisely by weighting using the machine learning, the amount of information to be processed also increases. It takes a considerable amount of time to calculate parameters.

In this regard, the delivery server 100 may train a convolutional neural network (CNN) on the basis of the data of each element of the above delivery row and user row related to the messages delivered in the past to generate a calculation model of the interest level parameter in advance, and calculate the interest level parameter of the above feature matrix using the calculation model. This makes it possible to accelerate the interest level parameter calculation processing and cope with the increase in the amount of information as described above.

As shown in FIG. 6, in the interest level parameter calculation processing, the CPU 11 first calculates each value of the delivery row in the feature matrix by the method described above (Step 61).

Subsequently, the CPU 11 calculates each value of the user row in the feature matrix by the method described above (Step 62).

Subsequently, the CPU 11 updates the feature matrix in the calculated delivery row and user row (Step 63).

The CPU 11 then calculates the interest level parameter of each user as the sum of the inner products of the updated feature matrix (Step 64).

Referring back to FIG. 4, subsequently, the CPU 11 selects a user whose interest level parameter has a predetermined value or larger, as a destination user of message redelivery, from all the users of the user group on the basis of the interest level parameter of each destination user calculated as described above (Step 51). Note that the selection processing includes not only the case of selecting a determinate destination user of redelivery, but also creating a group to be a plurality of candidate destination users as options to be proposed to the distributor.

Subsequently, the CPU 11 generates a message redelivery recommending screen on the basis of the calculated interest level parameter and the information of the selected destination user of redelivery (Step 52), and transmits the screen to the user terminal 200 of the distributor (Step 53).

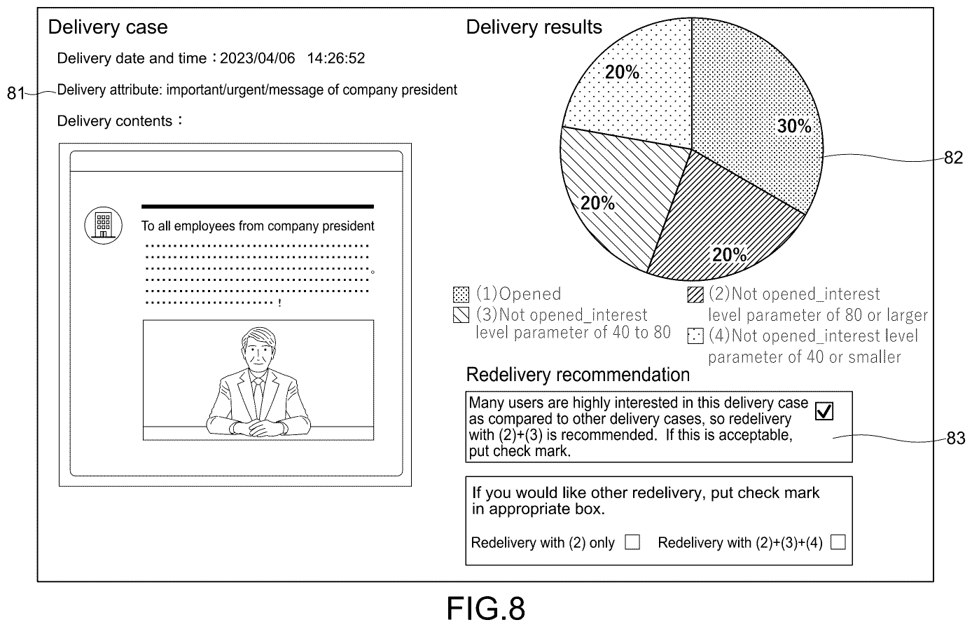

FIG. 8 is a diagram showing an example of the message redelivery recommending screen. As shown in the figure, the message redelivery recommending screen includes a delivery case information field 81, a delivery result display field 82, and a redelivery recommendation field 83.

The delivery case information field 81 includes information such as the delivery date and time of the message simultaneously delivered, the attribute (e.g., important/urgent/message of company president, etc.), and the contents of delivery.

The delivery result display field 82 displays statistical results based on the user's reaction (interest level parameter) to the message simultaneously delivered. For example, the statistical results are shown in a pie chart, showing the percentage of users who have opened the message among all the users to whom the message has been addressed, and the percentage of users in different value ranges of the interest level parameter among the users who have not opened the message.

The redelivery recommendation field 83 includes information for recommending a user group to be the target of redelivery of the message among the user groups respectively having different value ranges of the interest level parameter, and a check box for selecting the user group as the target of redelivery.

Specifically, for example, the destination users of the message are classified into the following four user groups: users who have opened the message (user group (1)); users who have not opened the message and whose interest level parameter is 80 or larger (user group (2)); users who have not opened the message and whose interest level parameter is from 40 to 80 (user group (3)); and users who have not opened the message and whose interest level parameter is 40 or smaller, the redelivery of the message to the above user groups (2) and (3) is recommended, and such redelivery can be selected using the check box. In addition, it is also possible to select redelivery in combination patterns of other user groups (user group (2) only, or user groups (2)+(3)+(4)).

In addition, the users who have opened the message (user group (1)) may also be recommended as destination users to whom the message is to be redelivered. Further, the users who have opened the message may also be determined to be recommended as destination users to whom the message is to be redelivered in accordance with the attribute such as the genre of the message. For example, for a message for prompting a user to perform some registration operation, like a notice of a health checkup, if the user opens the message and clicks a hyperlink (for registering a reservation for a health checkup) in the message, such a user may be excluded from the targets for redelivery of the message. On the other hand, if the message is not for prompting a user to perform some registration operation (merely prompting the user to view the message), like a message from the company president, even if the message has been opened, such a user may be recommended as a target for redelivery of the message if the interest level parameter is high.

Referring back to FIG. 4, if the user terminal 200 of the distributor determines that a message redelivery request operation has been received via the message redelivery recommending screen (Step 54), the user terminal 200 transmits a message redelivery request to the delivery server 100 (Step 55). The redelivery request contains information related to the destination users of the message (e.g., information of the user group selected in the delivery result display field 82 of the message redelivery recommending screen), and information similar to the message simultaneously delivered.

If the CPU 11 of the delivery server 100 then receives the redelivery request, the CPU 11 identifies a destination user of the message from the redelivery request (Step 56), and redelivers the message to the identified destination user (Step 57).

Until there are no more destination users to be recommended for redelivery, or until the number of times of redelivery reaches a predetermined number, the CPU 11 may repeatedly execute the processing of Step 48 and steps subsequent thereto in accordance with the user's reaction to the redelivered message.

### SUMMARY

As described above, according to this embodiment, the delivery server 100 extracts users in accordance with user's reactions to the message simultaneously delivered, and redelivers the message to those users, which makes it possible to reduce unnecessary redelivery of the message simultaneously delivered.

### MODIFIED EXAMPLES

The present invention is not limited to the embodiment described above and can be variously modified without departing from the gist of the present invention.

In the embodiment described above, the delivery server 100 makes a recommendation to the distributor about destination users when the message simultaneously delivered to all users of a user group is to be redelivered, but the delivery server 100 may also make a recommendation not in the situation of redelivery but in the initial delivery. In this case, the delivery server 100 determines destination users belonging to a user group in this message simultaneous delivery, from users belonging to a certain user group, in accordance with the interest level parameter calculated according to the user's reaction to the message simultaneously delivered in the past. Thus, the destination users can be narrowed down in advance to users with a high interest level in the message even in the initial delivery of the message.

In the embodiment described above, the delivery server 100 selects users to be the destination to which the same message as the message simultaneously delivered is to be redelivered, on the basis of the interest level parameter calculated in accordance with the user's reaction to the message simultaneously delivered. Instead, the delivery server 100 may select a destination user to be the destination to which a message related to the message simultaneously delivered is to be newly delivered, on the basis of the interest level parameter calculated in accordance with the user's reaction to the message simultaneously delivered. The related message is, for example, a message almost similar to the message simultaneously delivered but including update information, a message having any common attribute item of the attribute of the above message (e.g., message of the same genre as the past messages, message from the same department, etc.), and the like. In the embodiment described above, when the same message is redelivered, the users who have opened the message are excluded from the destination users, but when a related message is delivered, the users with high relevance parameters may be selected as the destination users, including the users who have opened the previous message.

In the embodiment described above, the delivery server 100 generates the message redelivery recommending screen for recommending destination users to whom the message simultaneously delivered is to be redelivered, provides the generated message redelivery recommending screen to the user terminal 200 of the distributor, and redelivers the message in accordance with a transmission request of the distributor in response to the provided screen. Instead, the delivery server 100 may automatically redeliver the message to the destination users who are determined to whom the message is to be redelivered without recommendation processing.

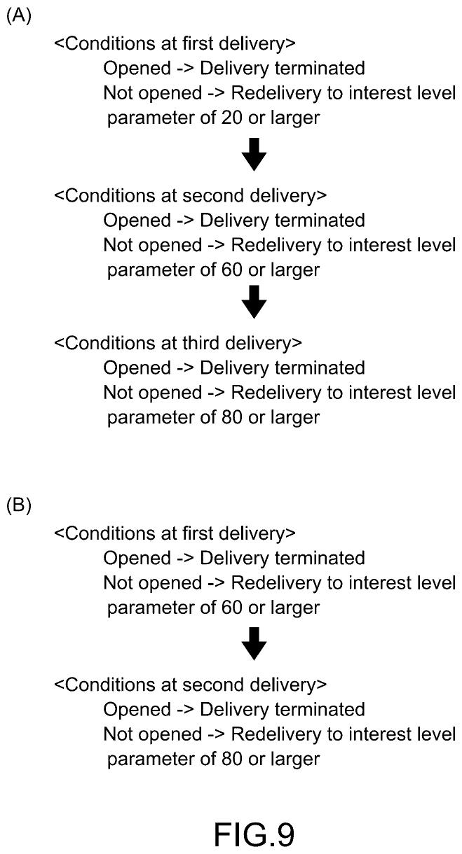

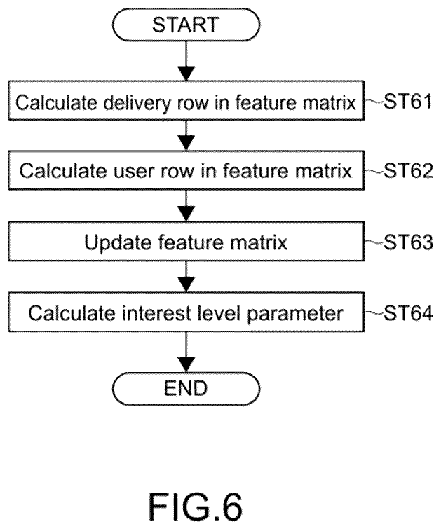

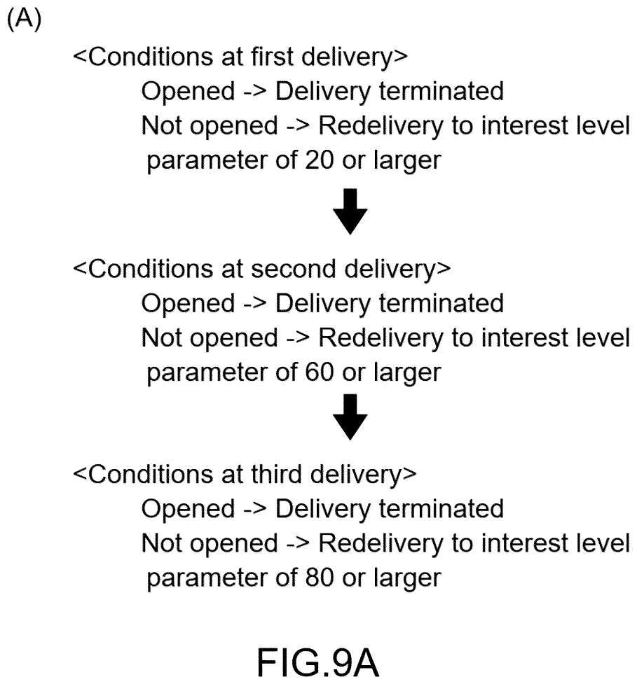

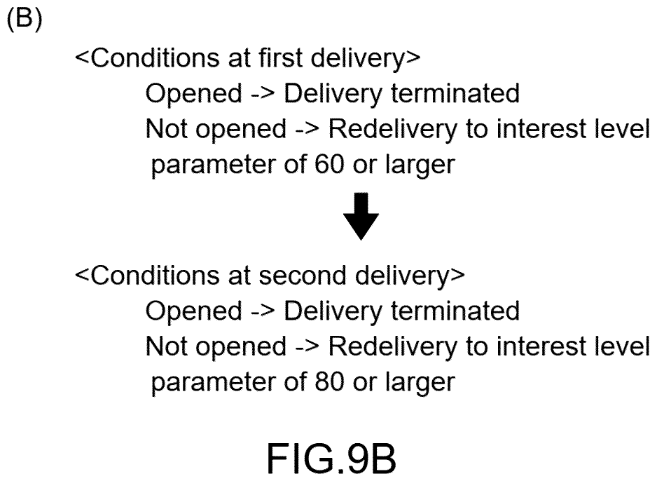

In this case, various conditions for automatic delivery can be assumed. FIG. 9 is a diagram for describing the conditions for automatic redelivery processing by the delivery server 100. As shown in (A) of the figure, in a sequence in which a message is widely redelivered for the moment but it is not redelivered to users who are not interested in the message at all, for example, the delivery server 100 selects, from among users who have not opened the message delivered at the first time, users having an interest level parameter of 20 or larger as the destination users for the second delivery, and performs delivery. Subsequently, the delivery server 100 selects, from among users who have not opened the message delivered at the second time, users having an interest level parameter of 60 or larger as the destination users for the third delivery, and performs delivery. The delivery server 100 then selects, from among users who have not opened the message delivered at the third time, users having an interest level parameter of 80 or larger as the destination users for the fourth delivery, and performs delivery.

Further, as shown in (B) of the figure, in a sequence in which a message is redelivered to only users who are interested, for example, the delivery server 100 selects, from among users who have not opened the message delivered at the first time, users having an interest level parameter of 60 or larger as the destination users for the second delivery, and performs delivery. The delivery server 100 then selects, from among users who have not opened the message delivered at the second time, users having an interest level parameter of 80 or larger as the destination users for the third delivery, and performs delivery.

The interest level parameter calculated in the embodiment described above is not only used for selecting a destination user to whom a message is to be redelivered, but also secondarily used for, for example, performing personnel evaluation or selecting an appropriate person for a project. For example, if the interest level parameter reveals an employee who is always talented and interested in management, a usage scene is conceivable in which such an employee is selected as an executive candidate or given an opportunity to be a project member. Thus, the delivery server 100 may extract users who have an interest level parameter of a predetermined value or larger for each attribute element and notify human resource managers or company executives of the information related to such users.

In the embodiment described above, the delivery server 100 calculates the interest level parameter for each of the users by a predetermined algorithm in accordance with the user's reaction to the message simultaneously delivered to all users of the user group, and selects a destination user to be a destination to whom the message is to be redelivered from all the users of the user group on the basis of the interest level parameter. However, the calculation of the interest level parameter by a predetermined algorithm is not indispensable, and instead, the delivery server 100 may determine for each user whether or not the user's reaction to the message simultaneously delivered satisfies a plurality of conditions, and select a destination user to be a destination to whom the message is to be redelivered in accordance with the result of the determination.

Here, the plurality of conditions refer to a combination of at least one condition regarding each element related to the attribute of the message in the embodiment described above (e.g., attribute elements related to the genre of the message, such as “health checkup” and “appointment letter”, attribute elements related to the degree of urgency of the message, such as “urgent” and “non-urgent”, and attribute elements related to the distributor (delivery source department), such as “human resources department” and “administration department”), and at least one condition regarding each element related to the user activity (e.g., whether the message has been opened/has not been opened, the number of times the message has been opened, the number of days taken until the message has been opened, the time in which the message has been displayed after opened, the number of times the hyperlink set in the message has been pressed, the presence/absence of a delivery archive, etc.), or refer to a plurality of conditions related to the user activity. More specifically, a condition that “when a message is important and has not been opened by a user, the message is to be redelivered to the user” may be provided.

In the embodiment described above, the example in which a message is assumed to be delivered to all employees in a company has been described, but the situation of the message delivery is not limited to companies. For example, the present invention is also applicable to the case where a civil service simultaneously delivers a message to citizens and residents of municipalities. In addition, the present invention is similarly applicable to the case where schools deliver messages to pupils, students, higher education students, and parents.

The delivery server 100 described in the above embodiment is illustrated as a single server but may be configured as a system in which the functions thereof are distributed among a plurality of servers or information processing apparatuses. For example, in the processing of the delivery server 100 in FIG. 4 described above, the interest level parameter calculation processing and the other processing may be distributed among a plurality of servers to be executed.

In the inventions described in the scope of claims of the present application, the invention described as an “information processing method” is one in which at least one apparatus such as a computer automatically performs each step by information processing performed by software, and is not performed by a human using an apparatus such as a computer. In other words, the “information processing method” is an information processing method performed by computer software and is not a method by a human operating a computational tool called a computer.

### REFERENCE SIGNS LIST

11 CPU
18 storage unit
19 communication unit
20 business communication tool
31 user information database
32 delivery information database
33 parameter information database
83 redelivery recommendation field
100 delivery server
200 user terminal

1. An information processing system, comprising
a controller that
simultaneously delivers a message to all of a plurality of users belonging to a predetermined user group, as destination users, on a basis of a request from a sender terminal,
calculates a parameter for each of the users by a predetermined algorithm in accordance with a reaction of the user to the message,
selects a destination user to be a destination to whom the message is to be redelivered, or a destination user to be a destination to whom a message related to the message is to be delivered, from all of the users on a basis of the calculated parameter, and
redelivers the message or delivers the related message to the selected destination user.

2. The information processing system according to claim 1, wherein
the controller generates a recommending screen capable of recommending redelivery of the message to the selected destination user and receiving a request of the redelivery, transmits the recommending screen to the sender terminal, and redelivers the message when the request of the redelivery is received from the recommending screen.

3. The information processing system according to claim 1, wherein
the controller calculates an activity value corresponding to an activity on a user terminal of each user with respect to the simultaneously delivered message, and an attribute value corresponding to an attribute of the message, and calculates the parameter on a basis of the activity value and the attribute value.

4. The information processing system according to claim 3, wherein
the controller calculates the activity value on a basis of time taken until the simultaneously delivered message has been opened by the user, the number of times the message has been opened, time in which the message has been displayed after opened, or the number of times a hyperlink set in the message has been pressed.

5. The information processing system according to claim 3, wherein
the controller calculates the attribute value on a basis of the degree of importance or the degree of urgency of the simultaneously delivered message, a category of message contents, or information related to a delivery source.

6. The information processing system according to claim 3, wherein
the controller calculates the parameter further on a basis of an activity history value corresponding to the activity of each user with respect to a message simultaneously delivered before the simultaneously delivered message.

7. The information processing system according to claim 1, wherein
the controller determines a user belonging to the predetermined user group in accordance with a parameter calculated in accordance with a reaction of the user to a message simultaneously delivered in a past.

8. The information processing system according to claim 1, wherein
the controller trains a convolutional neural network on a basis of data showing the reaction to a message simultaneously delivered in a past, generates a calculation model of the parameter as the predetermined algorithm, and calculates, using the calculation model, the parameter on a basis of data showing the reaction of the user to the message simultaneously delivered.

9. An information processing system, comprising
a controller that
simultaneously delivers a message to all of a plurality of users belonging to a predetermined user group, as destination users, on a basis of a request from a sender terminal,
determines for each of the users whether or not a reaction of the user to the message satisfies a plurality of conditions,
selects a destination user to be a destination to whom the message is to be redelivered, or a destination user to be a destination to whom a message related to the message is to be delivered, from all of the users in accordance with a result of the determination, and
redelivers the message or delivers the related message to the selected destination user.

10. An information processing method, comprising:
simultaneously delivering a message to all of a plurality of users belonging to a predetermined user group, as destination users, on a basis of a request from a sender terminal;
calculating a parameter for each of the users by a predetermined algorithm in accordance with a reaction of the user to the message;
selecting a destination user to be a destination to whom the message is to be redelivered, or a destination user to be a destination to whom a message related to the message is to be delivered, from all of the users on a basis of the calculated parameter; and
redelivering the message or delivers the related message to the selected destination user.

11. A program that causes an information processing apparatus to execute the steps of:
simultaneously delivering a message to all of a plurality of users belonging to a predetermined user group, as destination users, on a basis of a request from a sender terminal;
calculating a parameter for each of the users by a predetermined algorithm in accordance with a reaction of the user to the message;
selecting a destination user to be a destination to whom the message is to be redelivered, or a destination user to be a destination to whom a message related to the message is to be delivered, from all of the users on a basis of the calculated parameter; and
redelivering the message or delivering the related message to the selected destination user.

12. The information processing system according to claim 2, wherein
the controller calculates an activity value corresponding to an activity on a user terminal of each user with respect to the simultaneously delivered message, and an attribute value corresponding to an attribute of the message, and calculates the parameter on a basis of the activity value and the attribute value.

13. The information processing system according to claim 12, wherein
the controller calculates the activity value on a basis of time taken until the simultaneously delivered message has been opened by the user, the number of times the message has been opened, time in which the message has been displayed after opened, or the number of times a hyperlink set in the message has been pressed.

14. The information processing system according to claim 12, wherein
the controller calculates the attribute value on a basis of the degree of importance or the degree of urgency of the simultaneously delivered message, a category of message contents, or information related to a delivery source.

15. The information processing system according to claim 12, wherein
the controller calculates the parameter further on a basis of an activity history value corresponding to the activity of each user with respect to a message simultaneously delivered before the simultaneously delivered message.
